(19) United States
(12) Patent Application Publication
(10) Pub. No.: US 2005/0246181 A1
(43) Pub. Date: Nov. 3, 2005

(54) Method for credit card payment settlement and system for same

(76) Inventor: Hiroshi Kawahara, Chiba (JP)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/508,360

(22) PCT Filed: Mar. 20, 2003
(86) PCT No.: PCT/JP03/03467

§ 371 Date: Jun. 17, 2005

(30) Foreign Application Priority Data
Mar. 20, 2002 (JP) 2002-078128

(51) Int. Cl. G06F 17/60

(52) U.S. Cl. 705/1; 705/16; 705/17

(57) ABSTRACT

In a method and system for credit card payment settlement at an ordering site accepting via the Internet an order for a product or an application for a service of a credit card participating merchant, input of a part of the numerals of the card member number and input of attribute information, such as the name, date of birth, and address of the card member or user are accepted and these are used to identify whether or not the user matches with any credit card member, and in the case in which there such identification, invoicing for payment is performed with respect to the person responsible for payment of the card member's card.

### BACKGROUND OF THE INVENTION

1. Field of the Invention

The present invention relates to a system for credit card payment, and more particularly to a method of payment via a network, a method for assisting payment, and a system using these methods.

2. Related Art

In the past, a credit cards have been used widely for payment of products purchased by a consumer or customer via the Internet. When doing this, in addition to such information as the name of the purchaser, the delivery location, address, telephone number, and e-mail address, which is necessary as delivery information, information such as the credit card number and credit card expiration date was also required. Of the above-noted information input by the consumer, the purchaser's name, delivery location, telephone number, and e-mail address are used by the real or virtual net store (credit card participating shop or member shop) as the delivery location and contact point. The credit card number and expiration date are held by the store along with the member card number, expiration date, and amount of purchase, and submitted to the credit card company by a specified closing date.

For this reason, information such as the credit card number, the expiration date, and the name of the card holder, which must be kept in the greatest confidentiality from the standpoint of security in the credit card system, is transferred via the Internet, which is an open public system. Although in many cases care is taken to increase the security of this information by utilizing some encryption technology for the transmission of the information, encrypted communication may have problems associated with different encryption technologies. Additionally, encrypted communication technology, in attempting to use a further advanced technology to solve the problem of the fragile nature of the communication and Internet technologies, is difficult to understand for many user. For this reason, encrypted communication technology may pose a psychological barrier in purchasing products or services via the Internet.

A credit card number usually has as many as 16 digits, which include digits such as those representing the credit card issuing body, an individual card holder, and family members. Being asked to input a number such as this having 16 or nearly 16 digits is a factor that hinders the easy payment by use of a credit card.

Additionally, IC cards from a card-issuing company have recently been used to purchase at participating merchants. Technology for using this IC card is complex, and requires that the consumer (credit card holder) make application to a company issuing the IC card separate from the credit card company. Because of the occurrence of costs involved with the issuance of the IC card that and the distribution of IC card readers, there has been the problem of an additional cost being added to the credit card holder's yearly charges.

In addition, there is a system in which, at an Internet service provider (ISP) with which a consumer has a contract, the user's ISP member number is used in place of the credit card number, the user being made to input the member number and a password when making a purchase, and the payment therefore being invoiced to the credit card company registered by the consumer for automated debiting of by the ISP (for example, Nifty's i-REG service).

In addition, there is a system in which an application is received beforehand from the consumer, in response to which a temporary number is mailed to the consumer, thereby enabling shopping using that number (CYTOA, Secure Click Service).

For this reason, in a method or system for payment for sales for products and the like using the Internet, there is a desire for a method or system that does not cause the transmission of a credit card number, which is information that is to be kept in the greatest secrecy, via the public Internet, and which does not involve additional trouble or charges for the consumer.

### SUMMARY OF THE INVENTION

Accordingly, the present invention has as an object to provide a method or a system for payment for sales for products and the like using the Internet, there is a desire for a method or system that does not cause the transmission of a credit card number,4which is information that is to be kept in the greatest secrecy, via the Internet, and which enables settlement of payment between a credit card company and a participating merchant. In practicing the present invention, there is no need for a credit card holder (consumer) to make a new application, nor a need to enter into a new contract.

The order to achieve the above-noted object, one aspect of the present invention provides a method for credit card payment settlement at an ordering site of a credit card participating merchant which accepts orders for products or applications for services via the Internet or at an ordering site of a shopping mall which includes the participating merchant, this method having
a step of having an authentication computer accept credit card member number information and attribute information for a credit card holder from the member number information held by a credit card company and storing the credit card member information and the attribute information into an attribute information database;
a partial number information acceptance step of having the authentication computer accept a part of the credit card member number a user is using with respect to the ordering site and the result of input of attribute information inputted by the user;
a credit card member identification step of using the part of credit card member number and the attribute information, and referencing information stored in the attribute information database and determining whether the part of the credit card member number and the attribute information coincide with those of any credit card member; and
an ordering site-directed temporary number sending step, if the part of the credit card member number and attribute information are identified as being those of any credit card member, of having the authentication computer generate a temporary number in association with the credit card member number identified in the credit card holder member identification step and either sending the temporary number to a computer associated with the ordering site or storing information of the temporary number, so as to approve an order or application.

The present invention further provides a method for credit card payment settlement further having
a temporary number storage step of having the authentication computer store into a temporary number database the temporary number and the identified credit card member number; and
accepting invoicing data from the computer associated with the ordering site and an invoicing computer referencing the temporary number database, and sending to a person responsible for payments for the credit card, sending an invoice or invoicing data for the payment.

Additionally the present invention provides a credit card payment settlement system for credit card payment settlement at an ordering site of a credit card participating merchant which accepts orders for products or applications for services via the Internet or at an ordering site of a shopping mall established by the participating merchant, this system having
an attribute information database which accepts and stores a member number from the member numbers of a credit card company and attribute information of each member;
an authentication means which accepts a result of input of attribute information with regard to a card member of a credit card and part of the credit card member number used by the user of the ordering site, and which uses the part of the credit card member number and the attribute information, referencing information stored in the attribute information database to identify whether the part of the credit card member number and the attribute information match with any credit card member;
a ordering site directed temporary number generating means for, if the above-noted part of the credit card member number and attribute information are identified as being those of any credit card member, issuing a temporary number in association with the identified credit card member number, and sending the temporary number to a computer associated with the ordering site;
a temporary number database, which establishes an association between and stores the temporary number and an identified card member; and
an invoicing means for accepting invoicing data from the computer associated with the ordering site, referencing the temporary number database, and issuing an invoice or invoicing data for a payment

In the present invention, a computer is normally used throughout. This computer can be a host computer using a communication means such as a modem or the like, a hard disk, a floppy disk (trademark), and a data storage means such as a RAM or the like, which receives access either from a user's client computer, which has a numerical input means such as a keyboard or the like, a pointing device, and a display means or the like, or from a user's cellular phone that has an Internet connection function. The communication means is an data communication and indicating means which includes a modem for connection to the Internet or the World Wide Web, a user can use an information acquisition means such as an Internet browser that browses these. The present invention is implemented based on a general-purpose computer or communication means that can be used by a person skilled in the art.

In the foregoing, the ordering of a product and application for a service encompass general commercial transactions.

At an ordering site on the Internet, the results of selection of the type and quantity of product or service provided by a participating merchant-are accepted by a computer at the site. An instruction to make the payment for the product or service by a credit card and the result of selecting a credit card company are accepted by the computer at the site. This is as would conventionally be done in the method adopted by a site providing products or services on the Internet. Alternatively, it is possible to implement this system by using an ordering site computer that accept the results of selection of the type and quantity of product and service provided, an instruction to make the payment for the product or service by a credit card and the result of selecting a credit card company.

A step or means for accepting the results of selecting the type an quantity of a product or service, accepting an instruction to make payment by a credit card, and accept the results of selecting a credit card company is usually a computer associated with an Internet website established by a credit card participating merchant, an Internet homepage or website established as a shopping mall that is provided for the participating merchant, or any other arbitrary Internet website. When a user shops, this means is provided at an arbitrary website selected as the payment method. These websites can be sites in single location, or sites which are linked to one another, or sites that pop up on the user's display screen.

If a temporary number is used, regardless of whether the connection is by cable or by wireless, or even in the case of a network such as the Internet, which enables access to a third party's information, there is a reduced risk. The reason for this is that the temporary number can be made, by appropriate processing, a number that does not include the credit card number as is. This temporary number can further be changed for each transaction, even among transactions conducted by the same credit card member. Alternatively, it is possible to set the valid period for the number so as to be short If this is done, it becomes even more difficult to infer credit card number information, thereby achieving a highly secure transaction. This temporary number can further include the credit card number by using some form of encryption means. In this case, the encryption means increases the level of security. If there is sufficient security on the communication path, it is also possible to send the member number as is. Because the use of the temporary number does not extend to the path that requires the Internet (for example, between the user and the ordering site), the security of the communication path can sometimes be sufficient.

In the present invention, although an authentication computer used for member identification is under the control of a credit card company of the user's credit card, a credit card company having a shop as a participating merchant, a connection company performing authentication, a connection company augmented by a shopping mall, or an Internet service provider (ISP) or the like, the present invention is not restricted with respect to the administrator of the authentication computer. The foregoing is particularly effective in the case in which the credit card company of the user's credit card control the authentication computer (including the case in which there is an affiliation with credit card company with which the participating merchant is affiliated). This credit card company also manages the invoicing computer that performs invoicing processing for payment from the member.

The authentication computer need not be single computer. It is possible to have a plurality of physical computers mutually associated by an appropriate communication means and controlled with one another, enabling data exchange. Therefore, it is possible to have separate computers that are managed in conjunction with one another perform a step of accepting and storing into an attribute information database credit card member number information and attribute information or a step of accepting partial number information input, a step of identifying a credit card member, and a step of sending a temporary number for an ordering site. The invoicing computer, in the same manner, can be made a plurality of computers, and it is possible for this to be a computer that receives invoicing data from an ordering site and which can reference the temporary number database. The authentication computer and the invoicing computer can be single physical computers, and can completely separate computers. The invoicing computer also, similar to the authentication computer, can be controlled by any of the entities. For example, the authentication computer can be controlled by the credit card company, the authenticating organization, an Internet shopping mall, or an ISP. Taking the example of Japan, it is the credit card company which performs invoicing for the credit card and controls the invoicing computer.

The credit card member is for example an individual member who has joined a service of the credit card company, or a family member thereof holding a family card. The user is also a user who uses an Internet ordering site to receive products or services from a participating merchant, and while the user normally uses his or her own credit card, in the case of a corporate member or the like, the card user and the card owner do not necessarily coincide. In the same manner, the person responsible for payment can be the user or credit card member, and can alternatively be a different entity. In all cases, the user of an ordering site intends to pay via this credit card. It should be kept in mind in descriptions of the present invention, that the cases described are the normal cases in which the user is making use of his or her own credit card, and is the person responsible for payment, and that there is a possibility of changes such as with credit cards in the past, and that the present invention is not restricted to the case in which the user and the person owning or paying for credit card charges are one and the same.

The part of the member number that is numerical information of an arbitrary number of digits input by the user, which is a part of the credit card member number, which is usually approximately 16 digits, and which is capable identifying the credit card member. The credit card has digits that indicate the credit card company, and digits which indicate that the card is a family card. In the case of many credit card company, the credit card company is indicated by the first 3 or 4 digits. Family cards have a final 2 or 3 digits that differ between cards. Because the portion that indicates the credit card company and portion that indicates the family card are assigned in common to a large number of cards, if the part of the member number avoids these portions, it is possible to identify the cardholder with good efficiency with a smaller number of digits. However, it is also possible to include these digits as well, as necessary to verify the selected credit card company or to verify use of a family card. For this reason, it is possible to at first cause the input of the minimum number of digits in combination with the attribute information and, if that does not enable identification of a member, to prompt the user to input the number of digits required to identify the user.

In a case in which the credit card company is selected beforehand, or in which a credit card company issues a plurality of brands of credit cards, by causing the selection of the credit card company name and the brand name of the credit card, so as to identify the credit card brand beforehand, it is possible to eliminate the input of the digits (upper-order 4 digits) that identify the credit card company. This elimination does more than just reduce the number of digits of the number that are input. By selecting the credit card company so as to identify the credit card company, it is possible for the credit card company to more efficiently assign the part of the number (that is, make input of fewer digits). For example, in the case in which a company has a plurality of members with the same attribute information, in order for the credit card company to apply the present invention beforehand, the credit card company can compare each digit of the credit card numbers of the plurality of members and use common digits which have differences between the various plurality of members. Alternatively, it is possible in the case in which there is similarity between many of the numbers among such members, to change the number of digits used as the partial number for each member individually. At the time of registration of a new member, it is possible to take into consideration the attributes of existing members, and assign credit card numbers to new members such that a larger number of digits are assigned to members having the same attribute. In this manner, by selecting and identifying the credit card company beforehand, not only is the number of digits that is input reduced, but also it is possible to efficiently use the part of the number.

The card member attribute information is information entered by the card member at the time of applying for a credit card, information that is added or corrected based on such information, and includes such information as name, address, telephone number, and date of birth, as well as arbitrary information in the form of a character string or value (character string or the like) that is unique to each card member or user, or a combination of these. By making this information that the user would not easily forget, there is the advantage of eliminating the need for the user to refer to a note when making input. It is further possible to include a password for secrecy. By doing this, the user can make credit card payment with assurance of security. The card member attribute information includes a number of hardware used by the card member (referred to as the hardware identification number). This hardware identification number includes, for example, the manufacturing serial number of the hardware, the MAC address or IP address of a piece of network hardware, or the like. Using the hardware identification number, it is possible to identify the hardware used by a member, thereby enabling a narrowing down of members.

The credit card member database (member number information) usually is held by the credit card company. This member number database stores such things as valid credit card numbers and invalidated credit card numbers. The member number database can also be managed by an entity (such as a connection company) that provides information about the validity or invalidity of cards in place of the credit card company. Regardless of which entity is performing the management function, if appropriate updating and exchange is done of data, this can function as the member number database of the present invention. The member number database can, for example, instead of a connection company, be managed by a shopping mall or by an ISP.

The attribute information database is a database that stores attribute information regarding a user or credit card member input by a user. This attribute information is associated with the credit card number, and attribute information that assists in the identification of a member is stored. The records each credit card member in the attribute information database in this aspect of the present invention can also have a field made by extracting only part of the credit card number used by the member. If such a field is prepared, when the authentication computer references the attribute information database a search is performed first using part of the credit card number of a member used by a user, enabling the retrieval of records of credit card member for which that part coincides. After this is done, it is possible to identify from the matched records the members for which the attribute information coincides. By using part of the credit card number used by a credit card member as a field in this manner, it is possible for the authentication computer to quickly identify what member the user is.

In a case in which it is not possible using a part of the member number input by the user to identify the credit card member, it is possible to include a step or means that further increases the size of the number. By doing this, for users requiring more digits for identification (for example, family card members or members with the same first and last names), it is possible to cause the input of a number of other numbers.

When the authentication computer sends the temporary number for an ordering site, a computer associated with the ordering site receives this and recognizes that a user using the ordering site has been identified as using a valid credit card and that the card member has been identified. In such cases as those in which identification is not achieved, in which the card has expired, or in which the limit amount on a card is insufficient, it is possible to make an appropriate response. If the card is identified and is valid, the ordering site can use the temporary number to invoice the invoicing computer of the credit card company of the member later, a participating merchant operating the ordering site providing products and services to the user. After that, a computer associated with the ordering site sends an invoice for the payment to the invoicing computer of the credit card company. Upon receiving the invoice, the invoicing computer invoices the member. This processing can be performed by a method or system according to the above-noted present invention.

In any of this processing, neither some nor all of the digits of the member's credit card number is sent via the Internet. Even after identification of the card member, because only a part of the number is used, the credit card number is not sent. It is therefore possible after card member identification to use the Internet between the authentication computer and computer associated with the ordering site, thereby eliminating the need for a communication means other than the Internet.

Another aspect of the present invention provides a method for credit card payment at an ordering site of a credit card participating merchant which accepts orders for products or applications for services via the Internet or at an ordering site of a shopping mall established by the participating merchant, this method having
having an invoicing computer that issues an invoice or invoicing data for payment for use of a credit card establish a member identification symbol number for each payment invoice for each credit card member;
having the invoicing computer add to member number information of a credit card member the member identification symbol number;
having the invoicing computer issue to a person responsible for payment an invoice or invoicing data including the member identification symbol number;
having an authentication computer accept credit card member number information for each member, attribute information for each member, and a member identification symbol number for each member, from member number information of the credit card company issuing the card which the credit card member holds, and store the credit card member number information, the attribute information, and an attribute information database;
having the authentication computer accept the member identification symbol number used by the user of the ordering site and a result of the user inputting attribute information;
having the authentication computer reference information stored in the attribute information database based on the member identification symbol number and the attribute information of the user so as to identify whether there is a match by the member identification symbol number and the attribute information of the user with any member of the credit card holders, thereby identifying the credit card member;
when the user member identification symbol number and attribute information are identified as belonging to one of the credit card members, having the authentication computer either send to a computer associated with the ordering site or store a temporary number corresponding to the identified credit card member number, thereby approving the order or application;
having the authentication computer establishing an association between the temporary number and identified credit card member number and storing information regarding the association into a temporary number database; and
having the invoicing computer receive from the computer associated with the ordering site invoicing data about a new amount with regard to an order or an application, and reference the temporary number database to identify the person responsible for payment of the new amount.

In this aspect of the present invention, the member identification symbol number can be based on the invoice or invoicing data including the member identification symbol number, or based on a previous invoice or invoicing data.

This aspect of the present invention provides a credit card payment system at an ordering site of a credit card participating merchant which accepts orders for products or applications for services via the Internet or at an ordering site of a shopping mall established by the participating merchant, this system having
invoicing means wherein an invoicing computer issues an invoice or invoicing data for payment for use of a credit card of a credit card company for past usage of the card, and establishes a member identification symbol number for each payment invoice for each credit card member, the invoicing computer adds the member identification symbol number to member number information of a credit card member and includes the member identification symbol number of a person responsible for making payment in an invoice or invoicing data including the member identification symbol number, thereby issuing an invoice or invoicing data to the person responsible for making the payment;
an attribute information database, which accepts and stores credit card member number information for each member, attribute information for each member, and a member identification symbol number for each member which is to be included in the invoice or the invoicing data from member number information;
authentication means, which accepts the member identification symbol number used by the user of the ordering site and a result of the user inputting attribute information, and which referencing information stored in the attribute information database based on the member identification symbol number and the attribute information of the user so as to identify whether there is a match by the member identification symbol number and the attribute information of the user with any member credit card holder, thereby identifying the credit card member;
an ordering site directed temporary number sending means, which in a case in which the user member identification symbol number and attribute information are identified as belonging to one of the credit card members, issues and sends to a computer associated with the ordering site a temporary number corresponding to the identified credit card member number to a computer associated with the ordering site or storing a temporary number; and
a temporary number database, which establishes an association between and stores the temporary number and identified credit card member number,
wherein the invoicing means accepts the temporary number and invoicing data from the computer associated with the ordering site and referencing the temporary number database based on the temporary number, so as to issue an invoice or invoicing data to the person responsible for paying an invoice of the invoicing data, which includes an invoice or invoicing data that include the member identification symbol number of the member that is to be subsequently used.

In this aspect of the present invention, a number called the member identification symbol number is used. Notification of the number is given, along with an invoice or invoicing data, to the person responsible for credit card payment. In the case in which the person responsible for credit card payment is the user or the like of a participating merchant, the associated member identification symbol number and attribute information can be used to order a product or apply for a service. By using this member identification symbol number, it is possible for the person (user) responsible for payment who receives the invoice or the like to make a purchase, for example, without any sending of a credit card number. This member identification symbol number is basically an arbitrary character, symbol, or numerals or a combination thereof. For example, it is possible for the member identification symbol number to be made up of numerals, symbols, and letters of the alphabet or the like. Although the member identification symbol number is generally updated for each invoice, it is alternatively possible for it to remain unchanged over a number of invoices. If the member identification symbol number is updated for each invoicing, this symbol number is a number that is not the credit card number but rather only known by the credit card company and the credit card holder and that is updated frequently. It is therefore possible for the person responsible for credit card payment to feel at ease in using the credit card for payment.

Additionally, the member identification symbol number is generally only knowable to the person responsible for payment, who receives the invoice or invoicing data. Although the member identification symbol number is stored in the invoicing computer and a computer that might received information therefrom, this information is treated as secret. Thus, in the case in which the person responsible for credit card payment is the user or the like of a participating merchant, the person responsible for payment is able to shop with a feely of ease, using only information that he or she can know, without using a credit card number. In this aspect of the present invention, if the person responsible for payment is not the user of a participating merchant, for example in the case in which the person responsible for payment is having a family member use the family card, if that family member is a user of a participating merchant, as long as the member identification symbol number that is updated by the person responsible for payment is handled properly, it is possible at any time to allow or disallow the use of the family card.

In addition, with the above-noted aspect of the present invention, because of using attribute information it is possible to reduce the number of digits in the member identification symbol number. Since it is only necessary to use a member identification symbol number having enough digits that, combined with the attribute information, enables sufficient identification of the card member, compared to the case in which there is no attribute information used, it is easier to generate the member identification symbol number, enabling the authentication computer to identify the member in a short amount of time.

It is possible to have the member identification symbol number be based on the amount of an invoice or the like, in which case it is possible to use the invoiced amount itself as the member identification symbol number, and alternatively possible, for example, to generate a number of from the invoiced amount or encrypt the invoiced amount by some appropriate rule. The amount used as the basis for this can also be an amount that is other than an amount on the invoice or in the invoicing data that includes the member identification symbol number. It is possible to use the invoiced amount, the invoiced amount several months ago, or the actual amount paid in response to the invoice amount in this manner.

The record each credit card member in the attribute information in this aspect of the present invention can have a field that is formed by extracting just a part of the number of the credit card used by the member. If such a field is prepared, when the authentication computer references the attribute information database a search is performed first using part of the credit card number of a member used by a user, enabling the retrieval of records of credit card member for which that part coincides. After this is done, it is possible to identify from the matched records the members for which the attribute information coincides. By using part of the credit card number used by a credit card member as a field in this manner, it is possible for the authentication computer to quickly identify what member the user is.

Yet another aspect of the present invention is a method for assisting credit card payment at an ordering site of a credit card participating merchant accepting orders for products or applications for services or at an ordering site of a shopping mall of the participating merchant, this method having
a step of having an authentication computer accept credit card member number information and attribute information for credit card holder from the member number information of a credit card company and storing the credit card member information and the attribute information into an attribute information database;
a partial number input acceptance step of having the authentication computer accep a part of a credit card member number and an attribute information input by a user of the ordering site;
a credit card member identification step of using the part of credit card member number and the attribute information, referencing information stored in the attribute information database, and identifying whether the part of the credit card member number and the attribute information match with those of any credit card member;
an ordering site directed temporary number sending step, if the above-noted part of the credit card member number and attribute information are identified as being those of any credit card member, of having the authentication computer send a temporary number different from the member number indicating the credit card member identified in the credit card holder member identification step to a computer associated with the ordering site so as to approve an order or application;
a credit card company directed temporary number sending step of having the authentication computer sending, to a computer of the credit card company of the credit card member that accepts a temporary number, the temporary number and the card member number; and
a step of having the authentication computer establish an association between the temporary number and the identified credit card member and storing the temporary number and the identified card member in a temporary number database.

The present invention further provides a credit card payment assisting system for payment by credit card at an ordering site of a credit card participating merchant accepting orders for products or applications for services or at an ordering site of a shopping mall of the participating merchant, this system having
an attribute information database means for accepting and storing, from the credit card numbers of a credit card company, credit card numbers for each member and attribute information for each member;
authentication means for accepting a part of the credit card member number and a result of input of attribute information by the user and using the part of the credit card member number and attribute information to reference information stored in the attribute information so as to identify whether identifying the part of the credit card member number and the attribute information match with any credit card member;
ordering site-directed temporary number sending means, in a case in which the above-noted part of the credit card member number and attribute information are identified by the credit card member identifying means as being those of any credit card member, for generating a temporary number, that is different from the member number, but that indicates the credit card member identified in the credit card holder member identification means, and sending the temporary number to a computer associated with the ordering site;
credit card company-directed temporary number sending means for sending, to a computer of the credit card company of the credit card member that accepts a temporary number, the temporary number and the card member number; and
a temporary number database for associating and storing the temporary number and identified credit card member.

It will be understood that, while the foregoing aspects of the present invention are not restrictive, they are effective in a case in which a connection company, a shopping mall, a credit card company, and a connection company consigned by a credit card company manages the authentication computer. In this case, the connection company, the connection company assigned by a credit card company, a shopping mall, and an ISP priorly receive member number information and attribute information for each member from either the credit card company or the members. The authentication computer managing this information or the temporary number sending means sends the temporary number to the ordering site, and sends the temporary number and member number to the computer of the credit card company accepting the temporary number. The participating merchant, by the temporary number, knows that the credit card used by the user of the ordering site is valid, provides products or the like, and performs invoicing to the credit card company using the temporary number. The credit card company uses the received temporary number and the credit card member number to determine for which member the invoice from the participating merchant is intended, and performs invoicing relative to that member. Because communication between the authentication computer and the computer of the credit card company accepting temporary numbers need not be performed in real-time relative to operations performed by the user at the ordering site, it is possible to consider security when performing communication. Furthermore, the temporary number sending means performs communication in real time. Although the authentication computer and temporary number sending means perform real-time communication, amounts of money, numbers identifying participating merchants, time of authentication, and supplementary information can be sent as information used for verification.

In a case in which it is not possible to identify the credit card member, after the member identification step it is possible to add a step of the authentication computer searching for a member. By doing this, identification of the member is possible based on the latest information in the case in which the information received by the authentication computer from the credit card company is insufficient, or the updating is delayed.

By the above, even in the case in which the connection company, a shopping mall, or an ISP is managing the authentication computer, it is possible for perform credit card payment settlement at an Internet ordering site without having to enter all digits of the credit card number.

Yet another aspect of the present invention provides a method for assisting credit card payment at an ordering site of a credit card participating merchant accepting orders for products or applications for services or at an ordering site of a shopping mall of the participating merchant, this method having
a step of searching for attribute information of a user that is attempting to use a credit card to make payment for an ordered product or applied for service from attribute information stored in a storage means priorly accepted with regard to registered users using the ordering site, and
an input assistance step of having a computer of the ordering site send to an authentication computer, which performs identification of whether the users is a credit card member or not, at least a part of the attribute information of the searched for user.

The present invention additionally provides a system for assisting credit card payment at an ordering site of a credit card participating merchant accepting orders for products or applications for services or at an ordering site of a shopping mall of the participating merchant, this system having
storage means into which priorly accepted information with regard to registered users using the ordering site is stored; and
a computer of the ordering site, which searches the attribute information in the storage means for attribute information of a user attempting to use a credit card for payment of a purchased product or applied for service, and which sends this information to the authentication means that authenticates the credit card member as at least one part of the attribute information used to authenticate the credit card member.

The attribute information, for example, is general-purpose attribute information, for example, when a user has an ID for an Internet shopping mall, this attribute information being input when registering the ID, and accepted beforehand by a computer and stored in a storage means. The attribute information at the time of registering is an assisting means for identifying the member, and includes at least a part of the attribute information accepted at the time of authentication for credit card payment. For example, in the case in which the date of birth but not the address is input when registering at a shopping mall, in the present invention it is possible to use as attribute information used for credit card authentication, the attribute information at the time of registering with the shopping mall, which is stored in a storage means at that time, is used as the attribute information for credit card authentication, a search is made on the date of birth, and the user making further entry of the address in response to the transaction with the ordering site. It is sufficient for the user to make input only if previous input had been insufficient, or input of only a part that has changed for each transaction. There is no particular need to fix the location of storage of this attribute information. For example, it can be held by a computer managed by the shopping mall, or accumulated in a file (for example, as a cookie) used by the user and automatically output by the Internet site or a browser.

Furthermore, if the communication is done with the credit card by the participating merchant via a connection company, the participating merchant deals not with a plurality of credit card companies, but with a specific connection company, this being an advantage in simplifying ordering site (participating merchant) management and transactions. When going through a shopping mall, rather than individual users or participating merchant accessing the credit card company, there is the advantage of less danger of being subjected to attacks via the net. Seen from the standpoint of the connection company or credit card company, because the user no longer needs to input all digits and has a sense of security, there is the advantage of more activity at a general ordering site. In the present invention, if an appropriate encrypting means is used in the communication means such as the Internet, there is a further enhancement in security.

Any of the aspects of the present invention eliminate the direct handling of the credit card number by the participating merchant. There are cases in which some participating merchants perpetrate improprieties that result in losses to credit card companies and credit card holders. Even in such cases, however, in the present invention, in which does not use all digits of the credit card number, it is possible to increase the security when using a credit card.

In additional, in any of the aspects of the present invention, when performing authentication by any of the above-noted methods, an authentication computer receives a number (hardware identification number) for identification of a computer or terminal, making it possible, for example, to perform registration in association with the member number as part of the attributes of the attribute information database. When this is done, when subsequently authenticating the member, by checking the hardware identification number of the computer or terminal being used at that time, it is possible to infer what member is performing access as a user. That is, it is possible to store into the attribute information database the hardware identification number of the hardware such as a terminal used by the member, in association with the member number, and when this is done it is possible to make the hardware identification number a hardware identification number that can be obtained from the network. The member identification step can obtain the hardware identification number of the terminal being used by the user of the ordering site, and search the attribute information for the hardware identification number, and if there is a matching hardware identification number found by the authentication computer, the member is identified and this step is terminated. In the case in which there was not a matching in, the member identification step includes a step of the authentication computer storing into the attribute information database the hardware identification number in association with the member number.

That is, the present invention also provides a method for credit card payment or method for assisting credit card payment, in which the attribute information of each member includes a hardware identification number that identifies hardware used by a member, and which further includes a step of having the authentication computer accept the hardware identification number from the hardware used by the member and store the hardware identification number into the attribute information database, wherein if the currently identified member is a previously identified member, the credit card member identification step uses the hardware identification number as attribute information.

The present invention also provides system for credit card payment or system for assisting credit card payment, in which the attribute information of each member includes a hardware identification number identifying hardware used by the member, and the authentication means accepts a hardware identification number from hardware used by a member and stores the hardware identification number in the attribute information database and, in the case in which the currently identified member is a previously identified member, references the hardware identification number stored in the attribute information database, and identifies whether or not there is a match between the part of the credit card member number and the hardware identification number and those of any credit card member.

### BRIEF DESCRIPTION OF THE DRAWINGS

FIG. 1 is a block diagram of the present invention for the case in which the credit card company and the participating merchant are one and the same.

FIG. 2 is a block diagram of the present invention for the case in which a participating merchant has a direct relationship to the credit card company, and in which a member joins directly.

FIG. 3 is a block diagram of the present invention for the case in which there is a tie-up between a credit card company having a relationship with a participating merchant and credit card company to which the member belongs.

FIG. 4 is a block diagram showing the present invention for the case in which a connection company performs identification of a member by part of the credit card number, the expiration date of the credit card, and the attribute information.

FIG. 5 is a flowchart of operations in the present invention for the case in which a participating merchant has a direct tie-up with a credit card company and in which a member joins directly.

### DESCRIPTION OF THE PREFERRED EMBODIMENTS

### Embodiment 1

Embodiments of the present invention are described below in detail, with references made to relevant accompanying drawings.

The first embodiment of the present invention uses the fact that at the time of authentication of a card member, it is possible to perform the usual time of narrowing on personal information (hereinafter referred to as the attribute information) such as name, address, telephone number, and date of birth. Even without relying on all digits of the credit card number as was done in the past, by combining this attribute information with a part of the credit card number, it is possible to identify the card member from a large number of card members without hindering the operation of payment settlement by the credit card company.

The attribute information used to assist identification of the card member can be the delivery destination provided for a product, or a contact telephone number, or the like that is provided. This attribute information is information that needs less confidential handling than would the credit card number.

An authentication computer managed by a credit card company or the like makes an identification of whether or not a transaction is possible with a credit card member, based on this attribute information and a part of the credit card number. The credit card company constructs an appropriate database (attribute information database) for this purpose. The member attribute information used to construct this database can be an address, a telephone number, or a date of birth or the like that is provided to the credit card company at the time of application for membership as a credit card company member. Using a database constructed in this manner, it is possible to identify a credit card member without having the entire credit card number.

In this case, when shopping the credit card member accesses a website of the credit card participating merchant (ordering site), and cannot use the database of the credit card company directly. A link is established between a computer in which the credit card member's attribute information is registered and the website of the participating merchant at which the credit card member orders products or the like, and when the credit card member is ordering a product, for example, at the website of a participating merchant, the database (member number database or member number information) of the credit card company is accessed and attribute information having a low need for confidentiality is used to identify the member, without causing the entire member number of the credit card member to be transferred via the Web.

Once the member is identified, the credit card company transfers a separate temporary number to the credit card participating merchant. This temporary member number (temporary number) is stored in a database (temporary number database) in association with the normal member number of the identified member. When the credit card participating merchant is invoicing the credit card company for payment, this temporary number is used to that an invoice is made to that member for the purchase of the product or the like. With respect to the invoice using the temporary member number received by the credit card company from the participating merchant, the invoice to the actual credit card member is made using the usual member number, rather than the temporary number. Even without the credit card member knowing about the intervening temporary number, it is possible for the member to make payment in the same manner as in the past.

Consider the case in which the credit card company and the participating merchant are one and the same.

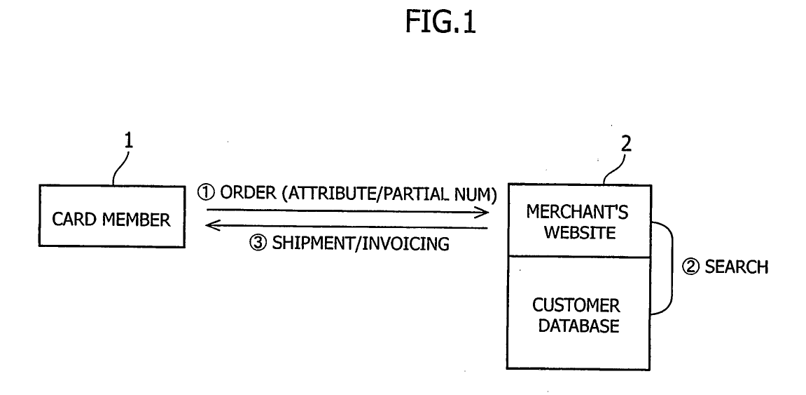

FIG. 1 shows the credit card company and the participating merchant are one and the same, and wherein the authentication computer of the present invention is managed thereby. This is a case, for example, in which the department store of a large retailer has a card organization within or under its organization.

A credit card member (or user) 1 of the department store orders a product or applies for a service at an ordering site 2 such as a website that enables ordering of products of the department store. When this is done, selection or input is done of the desired product or service type and quantity. The user also indicates the intention to pay by credit card. These selections and inputs are performed using an appropriate pointing device or other input means. The ordering site 2 is a public Internet website stored on an appropriate computer, which contains files coded in HTML or the like. In general, this is hypertext that can be openly accessed. It is possible to have generally usable hardware used by means of an appropriate database server or other data communication technology.

The credit card organization (or subsidiary or the like) constructs in a database means a customer database (a member number database or attribute information database).

When a computer (not shown in the drawing) that manages the ordering site 2 (including a computer either directly or indirectly connected to the ordering site 2) receives data from the ordering site 2, it is possible without any particular restriction to access its own company's client database or the like. This computer can also serve as the authentication computer. This computer uses member attribute information to perform narrowing of the range of members for selection, and can further uses a part of a credit card number to identify a card member. It is alternatively possible by part of a credit card number to narrow the range from a large number of members and to use the member attributes to perform the identification.

In the case of performing narrowing by means of the above-noted attribute information, the credit card member inputs information such as the credit card expiration date and the type of credit card, which is information that has little need to be kept confidential. This member inputs information until it is possible for the computer to identify the member, and there are cases in which identification of the member can be done with just attribute information. Even in a case in which identification is not possible, it is possible to narrow the range for searching. By this narrowing, in most cases it is sufficient to input just a part of the credit card number. The member inputs the required part of the credit card number.

By identifying the credit card member in this manner, if the member is one who can pay by credit card, the product is shipped to that member and invoicing is done at a later date.

Cases in which all digits of the credit card number are required in this method are extremely rare, so that it is substantially not necessary to consider such cases. In a case in which there is another member having similar attributes, the credit card company can avoid conflict by taking the approach of assigning to the members numbers that have a number of digits that differ. Additionally, if identification of a member is difficult using the number of digits that have already been input, the user can be prompted to input the required number of digits, which are then received.

Consider now a case in which a member directly joins a credit card company to which a participating merchant has a direct tie-up.

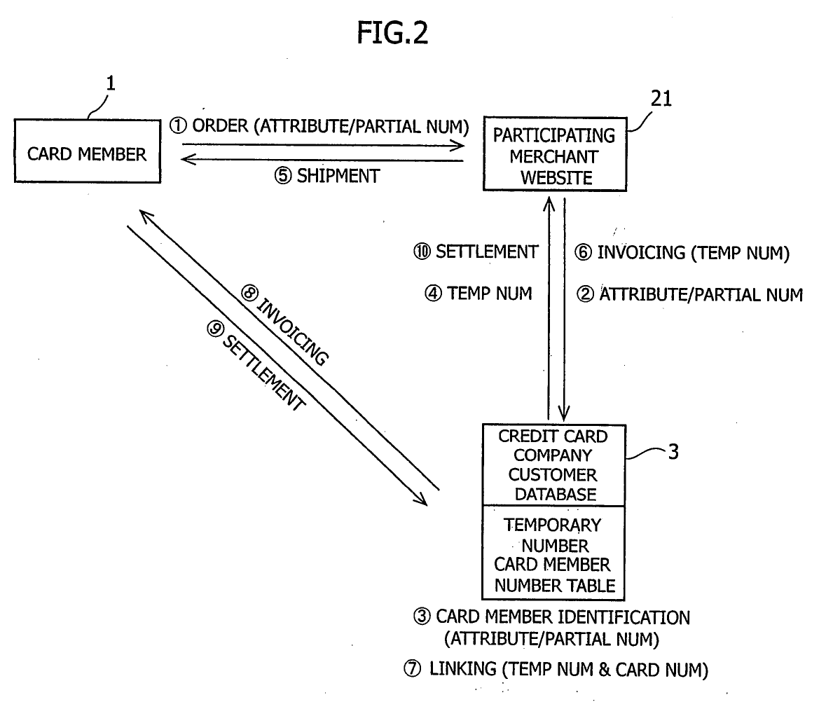

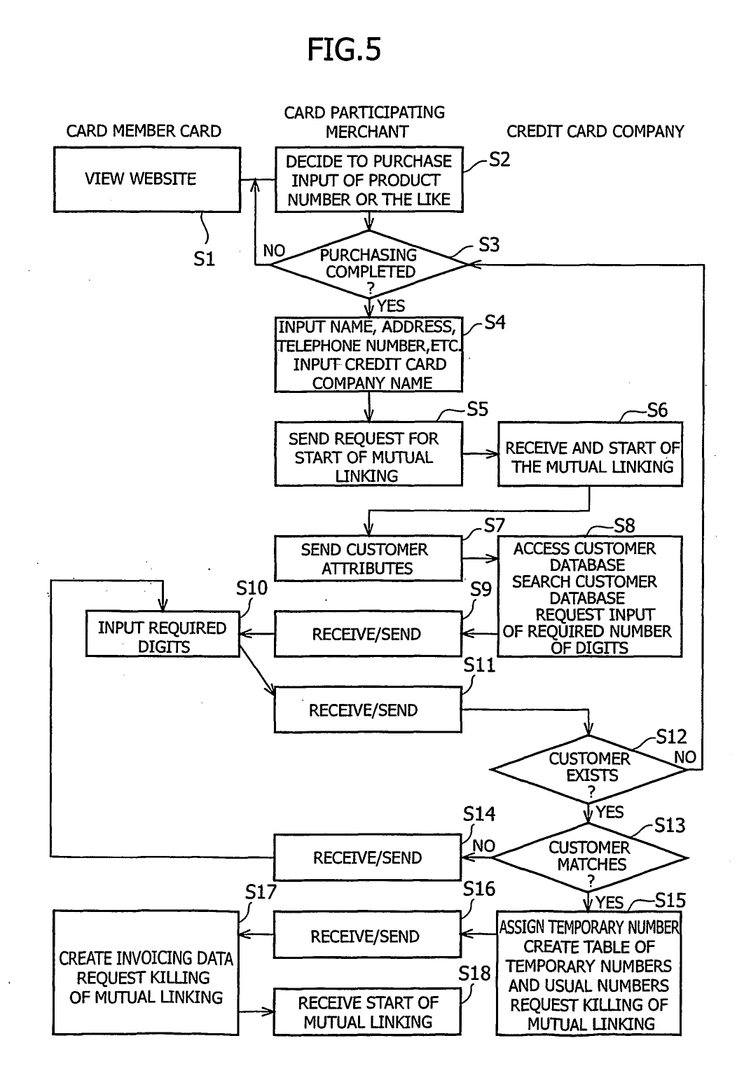

FIG. 2 and FIG. 5 illustrate another embodiment of the present invention.

In many cases when credit cards are used, there is a service tie-up between the company issuing the credit card and a company selling products or providing services. In this case, the database for identifying card members is at the credit card company, rather than the participating merchant.

The participating merchant forms a link leading to the credit card company on its website (ordering site) 21, and the credit card company generates a table for accepting linking from each participating -merchant on a one-to-base basis. After a user After a consumer (user) selects and inputs orders or the like (steps S1 to S3), a consumer the computer controlling the website 21 (not shown in the drawing) prompts the user to input such attribute information as the card member's address, name, telephone number, and credit card expiration date. When this is done, at the website of a participating merchant the user is made to select a credit card company (step S4). The computer controlling the website 21, by means of mutual links that have been priorly established, leads the user to the website of the selected credit card company (steps S5 to S7). This occurs by a click or other operation by the user, whereupon the computer controlling the ordering site or the user's client computer outputs a request for start of mutual linking, the computer of the credit card company 3 (including a website, database, or computer or the like controlling same) receiving this and sending the customer attributes to the credit card company site. The customer attributes that are sent include attribute information such as the user card member's address, name, telephone number, and credit card expiration date. A computer controlling the credit card company site requests input of a part of the credit card number (steps S8 to S11). This computer can be the authentication computer. The attribute information and the part of the credit card number are used, the computer managing the site of the credit card company accessing its own company customer database to identify whether the card member is one of its members and which member it is (steps S12, S13, and S10 in FIG. 5). If the identification succeeds, this is the case in which there is only a single card member that is identified by the input attribute information and partial credit card number, and if there is a plurality of members having matches with the attribute information and partial credit card number or if there is no such matching member, the identification fails. The computer of the credit card company, at the stage at which the attribute information input by the card member has been obtained (step S8), can alternatively perform a narrowing of the search based on this attribute information and partial credit card number. By doing this, it becomes possible to judge whether a specific card member is among the narrow range of card members (steps S12 and S13), whereupon the identification is completed.

After the identification of the card member, the computer of the credit card company issues a temporary member number corresponding to the usual member number (temporary number sending step and means), and stores this in its own company database (step S15, temporary number database). The computer of the credit card company sends the temporary member number to the participating merchant via a participating merchant link (step S16).

After the above, the product or service is provided to the user. If the product is subject to a cooling off, the progress of processing is stopped at this point, and invoicing for payment for the product or the like is not done.

In the case in which the participating merchant invoices the credit card company for payment, in place of the usual member number, the method of recording the temporary member number on a medium and sending it is used, thereby requesting payment settlement of the credit card company (FIG. 2 “issuance of temporary number at the time or order receipt”). An invoicing computer of the credit card company accesses its own company's database of usual member numbers and temporary member numbers located at its own company, based on the invoicing from the participating merchant using the temporary member number, and creates, based on the usual member number, invoicing data relative to the credit card company. After this is done, the member is directly invoiced and payment is requested.

In addition to the above-described procedure, it is also possible, without selecting attribute information, to lead the user to the site of a credit card company, and only then have the user input attribute information, which is accepted by an authentication computer. Another effective method is that of using an address that had been previously given to a participating merchant as a shipping destination as the attribute information, using this as an aid to the user in performing input.

Consider now a case in which there is a tie-up between a credit card company having a relationship with a participating merchant and credit card company to which the member belongs.

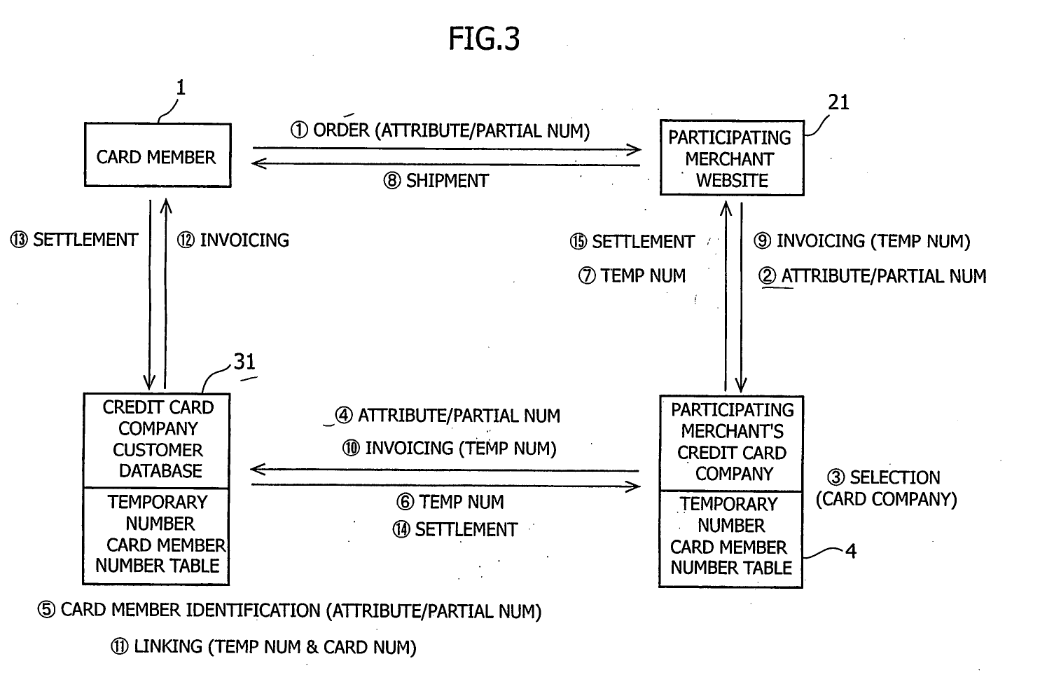

In addition to the cases described above, FIG. 3 illustrates the case in which there is a plurality of intervening credit card companies. The case of a plurality of intervening credit card companies occurs when the company having a relationship with the participating merchant is different from the credit card company issuing the card held by the credit card member. In this case, the relationship between a website of a credit card company with which a participating merchant has a participation relationship and the website of the participating merchant has the above-noted mutually linked relationship. Additionally, there is the same one-to-one relationship between the website of a credit card company with which the participating merchant has a participation relationship and the website of a credit card company holding the card member data Thus, there is a one-to-one relationship between the participating merchant as seen from the credit card company with which the participating merchant has a participating relationship and the credit card company to which a member application is made. The management of the authentication computer can be done by a computer of either credit card company. For the purpose of this description, the authentication computer will be assumed to be managed by the credit card company issuing the member's credit card.

The credit card company to which the participating merchant has belongs makes a request to the credit card company issuing the member's credit card for a search of credit card member data, and obtains a temporary number member number. The credit card company with which the participating merchant has a tie-up either sends this temporary member number to the participating merchant as is, or constructs a database that accesses the temporary member number obtained from the credit card company for which the credit card member has made an application and the participating merchant temporary member number and sends the temporary member number to the participating merchant.

The invoicing for sales on the part of the three parties, these being the participating merchant, the credit card company with which the participating merchant participates, and the credit card company to which the application is made by the credit card member, is performed using the temporary member number. The credit card company to which the credit card member makes application ultimately invoices the credit card holder (member) based on the usual member number. In this manner, even in the case in which it is necessary to perform transfer between a plurality of credit card companies, by performing this using a temporary member number the usual member number of a credit card holder is not sent outside of the credit card company issuing the credit card, nor is it sent directly by the credit card holder. Communication for payment settlement between the credit card company issuing the credit card holder's card and the credit card company with which the participating merchant participates can be handled together until the invoicing is done to the card member.

Consider now a case in which a connection company identifies a card member by a part of the credit card number, the expiration date of the credit card, and attribute information with regard to the member.

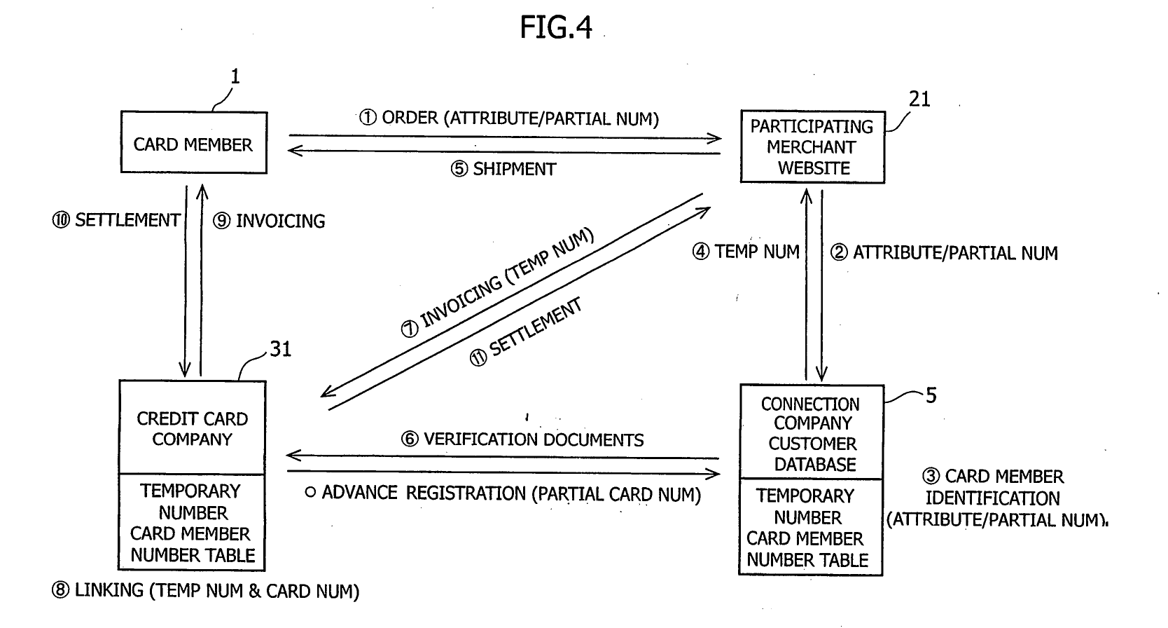

Referring to FIG. 4, the case of identifying a credit card via a connection company is as follows. The connection company manages the authentication computer and, between the credit card participating merchant and the credit card company, a card member is identified by means of part of the credit card number, or the credit card expiration date, and attribute information of the credit card holder or the like. The term connection company used herein refers to an entity providing credit references between a plurality of credit card companies and participating merchants, such as CAFIS (Credit and Finance Information System; trademark). By means of this connection company not only is it possible for a participating merchant by communicating only with the connection company, to participate in services of a plurality of credit card companies, it is also possible for a credit card company to reduce the amount of communication it does with individual participating merchants, and there is the advantage of having the connection company maintaining services at times when the computer is not operating, this advantage resulting in this arrangement being already in general use.

In the case of operating via a connection company 5, the credit card company beforehand passes to the authentication computer the attribute information that can assist in identifying a credit card member (digit positions of the credit card number required to be input, expiration date, and credit card member (holder) name and the like). Additionally, there is a link relationship established between the ordering site of the credit card participating merchant and the authentication computer managed by the connection company. In a case in which a credit card member makes an order for a product at the website of a participating merchant and credit card payment is made according to the present invention, the authentication computer of the connection company accepts part of the credit card number, attribute information of the credit card member, and the credit card expiration date. If this input enables identification of the credit card member and also verification that the credit card is valid, the authentication computer issues a temporary member number to a computer associated with the ordering site of the participating merchant. One example that can be envisioned in which identification is not possible or verification is not made that the credit card is valid would be a case in which the information priorly obtained by the authentication computer is insufficient. In such a case, in addition to the part of the credit card number already input, it is possible to adopt a configuration in which the number of digits of the credit card number that are input is increased, and to prompt for the input of the additional digits, which are also sent to the authentication computer. Then the product or service is then provided. After this is done, the authentication computer sends to the credit card company a number identifying the participating merchant, and a record of the usage of a temporary member number.

In this embodiment of the present invention, there are two different forms of the credit card participating merchant invoicing for the payment. In the first form, which is shown in FIG. 4, the credit card participating merchant, in the same manner as when conventionally using a credit card, invoices the credit card company for the payment for the transaction. When this is done, the credit card participating merchant uses a temporary number. The credit card company can reference the temporary number from the participating merchant and a record of sales from the connection company so as to ensure security. The credit card company, based on this usual member number information, performs invoicing of the card member, and the card member or the person responsible for payment makes the payment.

In the second form (not shown in the drawing), the credit card participating merchant invoices the connection company for the payment for a transaction. In this case as well, similar to the first form, the credit card participating merchant performs invoicing using a temporary number. The connection company can establish an association between the temporary number from the participating merchant and the usual member number, and can invoice the credit card company for the payment using the usual credit card number. The credit card company, based on the usual member number information, invoices the card member for the payment, and the card member or the person responsible for payment makes the payment. In this second form, the credit card number for identifying the card member is transmitted beforehand to an authentication company.

In this example as well, although there is a connection company intervening between the participating merchant and the credit card company, in handling a transaction with the credit card company, it is not necessary for the credit card member to input the entire credit card number. Additionally, because the connection company that receives beforehand from the credit card company the part of the credit card number and the attribute information can identify a card member, the need for the credit card company itself to identify the card member is eliminated, thereby enabling the connection company to batch transmit transaction information to the credit card company at an appropriate time.

### Embodiment 2

A second embodiment of the present invention, in which it is possible to perform credit card payment without sending the credit card number at all.

In making a credit card payment settlement, notification is given to the person responsible for payment, using a conventional invoice or the like, with regard to payments for usage of the credit card over a given period of time. Because this notification indicates the invoiced amount which the person responsible for payment absolutely must pay, in contrast to other direct mail or the like, there is an extremely high probability that it will be looked at by the person responsible for payment. While this invoice can be one that is delivered by the postal system or the like used in the past, it can also be delivered as invoicing data in the form of electronic mail. In this case as well, it is almost certain that the person responsible for payment will look at the notification.

By indicating on such an invoice or the like a symbol, number, or code that is frequently updated as a member identification number, it is possible to make sure notification of the member identification symbol number to the person responsible for payment. Although this type of member identification symbol number can be made absolutely arbitrary, the present invention is predicated on combining the member identification symbol number with the attribute information. Therefore, the member identification symbol number can be made a number or the like:that has a number of digits that is less than those of the credit card number. The invoice or the like often has the invoiced amount along with payment amounts for the past several months. Both of these type of amounts vary in accordance with transactions, and actually take on various values. Furthermore, these amounts in general fluctuate between each issued invoice. It is thus possible to treat such an amount as being pseudo-random, and to use all of these values or a part thereof as a member identification symbol number.

In this embodiment of the present invention, an invoicing computer first establishes a member identification symbol number that includes the amount invoiced to the credit card member. The invoicing computer is a computer that issues an invoice or invoicing data for payments of past usage of a credit card. The member identification symbol number is added to a database into which is stored member number information for credit card members. Along with member numbers the member number information contains a record of the attribute information of members. The member identification symbol number is indicated on the invoice or the like. As described above, the member identification symbol number is formed by the appropriate selection of symbols and numerals, and can at that point be the invoiced amount itself, or a previously invoiced amount, or even a completely random creation. Alternatively, it can be an encrypted version of a symbol or number having a meaning.

The authentication computer, from the member number information of the credit card company issuing the credit card used by the card member, accepts the credit card member number information of each member, the attribute information of each member, and the member identification symbol numbers of each member, and store this information into an attribute information database. This authentication computer, for example, c,an access the attribute information at any time. By allowing the authentication computer to access the attribute information database at any time, it is possible for the authentication computer to identify a member from the member identification symbol number and attribute information stored therein.

A user of a website of a participating merchant, by inputting the member identification symbol number and attribute information, purchase a product or applies for a service. The results of this input are received by the authentication computer.

The authentication computer, based on the user's member identification symbol number and attribute information, accesses information stored in the attribute information database, so as to perform identification by verifying whether there is a match between the user's member identification symbol number and attribute information with any credit card member. By doing this, it is possible to identify which card member's card is used to make payment, and for the authentication computer to authenticate the credit card transaction.

If the authentication succeeds, the a temporary number corresponding to the credit card member number identified by the credit card member identification step is sent by the authentication computer to a computer associated with the ordering site or this information is stored, thereby approving the order or application. This temporary number and identified credit card member number are associated with one another and stored in a temporary number database by the authentication computer.

The invoicing computer receives from the computer associated with the ordering site invoicing data of a new amount in accordance with the order or application and the above-noted temporary number. This received invoicing data has already been authenticated as being that of the credit card member represented by the temporary number. For this reason, by accessing the temporary number database, it is possible to easily identify the person responsible for payment for the new amount.

By doing this, it is possible to perform settlement of a series of transactions using a credit card. After the settlement is done, when a new amount is to be invoiced, because this will become a past amount at the time of invoicing, by executing the series of steps from the start, it is possible subsequently to use an updated member identification symbol number to continue settlement of payment.

When a consumer purchases a product or applies for a service at a website of a participating merchant, there is uneasiness on the part of the consumer when inputting the entire credit card number. By using the present invention as described in detail above, the need to input the entire of a credit card number is eliminated, thereby eliminating the uneasiness that the consumer formerly often had. Therefore, even for a consumer who feels uneasy inputting a credit card number as is, the present invention makes it possible to use the Internet freely and easily to purchase products and apply for services.

Even if the credit card member data should be read over a communication path, because it is only partial, there is a significant improvement in security. Additionally, by having a credit card member input part of the member's credit card number when shopping, it is possible to develop a sense of the intention to make a transaction involving a payment, thereby providing verification of intent, and preventing mischief. In the case in which the number of credit card number digits input by the credit card member is increased or decreased or a different credit card number is input, by setting the number of failures allowed, it is possible to control the level of security.

In the case in which the credit card number itself is not used at all, there is a further improvement in the perceived security by not using a credit card number.

Additionally, in none of the foregoing embodiments of the present invention does a participating merchant handle the credit card number directly. The use of a credit card payment settlement method or system according to the present invention therefore provides an improvement in security when using a credit card.

1. A method for credit card payment settlement at an ordering site of a credit card participating merchant which accepts orders for products or applications for services via the Internet or at an ordering site of a shopping mall which includes the participating merchant, the method comprising:
a step of having an authentication computer accept credit card member number information and attribute information for a credit card holder from the member number information held by a credit card company and storing the credit card member information and the attribute information into an attribute information database;
a partial number information acceptance step of having the authentication computer accept a part of the credit card member number a user is using with respect to the ordering site and the result of input of attribute information inputted by the user;
a credit card member identification step of using the part of credit card member number and the attribute information, and referencing information stored in the attribute information database and determining whether the part of the credit card member number and the attribute information coincide with those of any credit card member; and
an ordering site-directed temporary number sending step, if the part of the credit card member number and attribute information are identified as being those of any credit card member, of having the authentication computer generate a temporary number in association with the credit card member number identified in the credit card holder member identification step and either sending the temporary number to a computer associated with the ordering site or storing information of the temporary number, so as to approve an order or application.

2. A credit card payment settlement method according to claim 1, further comprising:
a temporary number storage step of having the authentication computer store into a temporary number database the temporary number and the identified credit card member number; and
accepting invoicing data from the computer associated with the ordering site and an invoicing computer referencing the temporary number database, and sending to a person responsible for payments for the credit card, sending an invoice or invoicing data for the payment.

3. A method for credit card payment at an ordering site of a credit card participating merchant which accepts orders for products or applications for services via the Internet or at an ordering site of a shopping mall established by the participating merchant, this method comprising the steps of:
having an invoicing computer that issues an invoice or invoicing data for payment for use of a credit card establish a member identification symbol number for each payment invoice for each credit card member;
having the invoicing computer add to member number information of a credit card member the member identification symbol number;
having the invoicing computer issue to a person responsible for payment an invoice or invoicing data including the member identification symbol number;
having an authentication computer accept credit card member number information for each member, attribute information for each member, and a member identification symbol number for each member, from member number information of the credit card company issuing the card which the credit card member holds, and store the credit card member number information, the attribute information, and an attribute information database;
having the authentication computer accept the member identification symbol number used by the user of the ordering site and a result of the user inputting attribute information;
having the authentication computer reference information stored in the attribute information database based on the member identification symbol number and the attribute information of the user so as to identify whether there is a match by the member identification symbol number and the attribute information of the user with any member of the credit card holders, thereby identifying the credit card member;
when the user member identification symbol number and attribute information are identified as belonging to one of the credit card members, having the authentication computer either send to a computer associated with the ordering site or store a temporary number corresponding to the identified credit card member number, thereby approving the order or application;
having the authentication computer establishing an association between the temporary number and identified credit card member number and storing information regarding the association into a temporary number database; and
having the invoicing computer receive from the computer associated with the ordering site invoicing data about a new amount with regard to an order or an application, and reference the temporary number database to identify the person responsible for payment of the new amount.

4. A credit card payment settlement method according to claim 3, wherein the member identification symbol number is based on the invoice or invoicing data including the member identification symbol number, or based on a previous invoice or invoicing data.

5. A method for assisting credit card payment at an ordering site of a credit card participating merchant accepting orders for products or applications for services or at an ordering site of a shopping mall of the participating merchant, the method comprising:
a step of having an authentication computer accept credit card member number information and attribute information for credit card holder from the member number information of a credit card company and storing the credit card member information and the attribute information into an attribute information database;
a partial number input acceptance step of having the authentication computer accep a part of a credit card member number and an attribute information input by a user of the ordering site;
a credit card member identification step of using the part of credit card member number and the attribute information, referencing information stored in the attribute information database, and identifying whether the part of the credit card member number and the attribute information match with those of any credit card member;
an ordering site directed temporary number sending step, if the above-noted part of the credit card member number and attribute information are identified as being those of any credit card member, of having the authentication computer send a temporary number different from the member number indicating the credit card member identified in the credit card holder member identification step to a computer associated with the ordering site so as to approve an order or application;
a credit card company directed temporary number sending step of having the authentication computer sending, to a computer of the credit card company of the credit card member that accepts a temporary number, the temporary number and the card member number; and
a step of having the authentication computer establish an association between the temporary number and the identified credit card member and storing the temporary number and the identified card member in a temporary number database.

6. A method for assisting credit card payment at an ordering site of a credit card participating merchant accepting orders for products or applications for services or at an ordering site of a shopping mall of the participating merchant, this method comprising:
a step of searching for attribute information of a user that is attempting to use a credit card to make payment for an ordered product or applied for service from attribute information stored in a storage means priorly accepted with regard to registered users using the ordering site; and
an input assistance step of having a computer of the ordering site send to an authentication computer, which performs identification of whether the users is a credit card member or not, at least a part of the attribute information of the searched for user.

7. A method according to claim 1, wherein the attribute information of each member includes a hardware identification number that identifies hardware used by a member, and which further includes a step of having the authentication computer accept the hardware identification number from the hardware used by the member and store the hardware identification number into the attribute information database, wherein if the currently identified member is a previously identified member, the credit card member identification step uses the hardware identification number as attribute information.

8. A credit card payment settlement system for credit card payment settlement at an ordering site of a credit card participating merchant which accepts orders for products or applications for services via the Internet or at an ordering site of a shopping mall established by the participating merchant, the system comprising:
an attribute information database which accepts and stores a member number from the member numbers of a credit card company and attribute information of each member;
an authentication means which accepts a result of input of attribute information with regard to a card member of a credit card and part of the credit card member number used by the user of the ordering site, and which uses the part of the credit card member number and the attribute information, referencing information stored in the attribute information database to identify whether the part of the credit card member number and the attribute information match with any credit card member;
a ordering site directed temporary number generating means for, if the above-noted part of the credit card member number and attribute information are identified as being those of any credit card member, issuing a temporary number in association with the identified credit card member number, and sending the temporary number to a computer associated with the ordering site;
a temporary number database, which establishes an association between and stores the temporary number and an identified card member; and
an invoicing means for accepting invoicing data from the computer associated with the ordering site, referencing the temporary number database, and issuing an invoice or invoicing data for a payment.

9. A credit card payment system at an ordering site of a credit card participating merchant which accepts orders for products or applications for services via the Internet or at an ordering site of a shopping mall which includes the participating merchant, the system comprising:
invoicing means wherein an invoicing computer issues an invoice or invoicing data for payment for use of a credit card of a credit card company for past usage of the card, and establishes a member identification symbol number for each payment invoice for each credit card member, the invoicing computer adds the member identification symbol number to member number information of a credit card member and includes the member identification symbol number of a person responsible for making payment in an invoice or invoicing data including the member identification symbol number, thereby issuing an invoice or invoicing data to the person responsible for making the payment;
an attribute information database, which accepts and stores credit card member number information for each member, attribute information for each member, and a member identification symbol number for each member which is to be included in the invoice or the invoicing data from member number information;
authentication means, which accepts the member identification symbol number used by the user of the ordering site and a result of the user inputting attribute information, and which referencing information stored in the attribute information database based on the member identification symbol number and the attribute information of the user so as to identify whether there is a match by the member identification symbol number and the attribute information of the user with any member credit card holder, thereby identifying the credit card member;
an ordering site directed temporary number sending means, which in a case in which the user member identification symbol number and attribute information are identified as belonging to one of the credit card members, issues and sends to a computer associated with the ordering site a temporary number corresponding to the identified credit card member number to a computer associated with the ordering site or storing a temporary number; and
a temporary number database, which establishes an association between and stores the temporary number and identified credit card member number,
wherein the invoicing means accepts the temporary number and invoicing data from the computer associated with the ordering site and referencing the temporary number database based on the temporary number, so as to issue an invoice or invoicing data to the person responsible for paying an invoice of the invoicing data, which includes an invoice or invoicing data that include the member identification symbol number of the member that is to be subsequently used.

10. A credit card payment assisting system for payment by credit card at an ordering site of a credit card participating merchant accepting orders for products or applications for services or at an ordering site of a shopping mall of the participating merchant, the system comprising:
an attribute information database means for accepting and storing, from the credit card numbers of a credit card company, credit card numbers for each member and attribute information for each member;
authentication means for accepting a part of the credit card member number and a result of input of attribute information by the user and using the part of the credit card member number and attribute information to reference information stored in the attribute information so as to identify whether identifying the part of the credit card member number and the attribute information match with any credit card member;
ordering site-directed temporary number sending means, in a case in which the above-noted part of the credit card member number and attribute information are identified by the credit card member identifying means as being those of any credit card member, for generating a temporary number, that is different from the member number, but that indicates the credit card member identified in the credit card holder member identification means, and sending the temporary number to a computer associated with the ordering site;
credit card company-directed temporary number sending means for sending, to a computer of the credit card company of the credit card member that accepts a temporary number, the temporary number and the card member number; and
a temporary number database for associating and storing the temporary number and identified credit card member.

11. A system for assisting credit card payment at an ordering site of a credit card participating merchant accepting orders for products or applications for services or at an ordering site of a shopping mall of the participating merchant, the system comprising:
storage means into which priorly accepted information with regard to registered users using the ordering site is stored; and
a computer of the ordering site, which searches the attribute information in the storage means for attribute information of a user attempting to use a credit card for payment of a purchased product or applied for service, and which sends this information to the authentication means that authenticates the credit card member as at least one part of the attribute information used to authenticate the credit card member.

12. A system according to claim 8, wherein
the attribute information of each member includes a hardware identification number identifying hardware used by the member, and
the authentication means accepts a hardware identification number from hardware used by a member and stores the hardware identification number in the attribute information database and, in the case in which the currently identified member is a previously identified member, references the hardware identification number stored in the attribute information database, and identifies whether or not there is a match between the part of the credit card member number and the hardware identification number and those of any credit card member.

13. A method according to any one of claim 2, wherein the attribute information of each member includes a hardware identification number that identifies hardware used by a member, and which further includes a step of having the authentication computer accept the hardware identification number from the hardware used by the member and store the hardware identification number into the attribute information database, wherein if the currently identified member is a previously identified member, the credit card member identification step uses the hardware identification number as attribute information.

14. A method according to any one of claim 3, wherein the attribute information of each member includes a hardware identification number that identifies hardware used by a member, and which further includes a step of having the authentication computer accept the hardware identification number from the hardware used by the member and store the hardware identification number into the attribute information database, wherein if the currently identified member is a previously identified member, the credit card member identification step uses the hardware identification number as attribute information.

15. A method according to any one of claim 4, wherein the attribute information of each member includes a hardware identification number that identifies hardware used by a member, and which further includes a step of having the authentication computer accept the hardware identification number from the hardware used by the member and store the hardware identification number into the attribute information database, wherein if the currently identified member is a previously identified member, the credit card member identification step uses the hardware identification number as attribute information.

16. A method according to any one of claim 5, wherein the attribute information of each member includes a hardware identification number that identifies hardware used by a member, and which further includes a step of having the authentication computer accept the hardware identification number from the hardware used by the member and store the hardware identification number into the attribute information database, wherein if the currently identified member is a previously identified member, the credit card member identification step uses the hardware identification number as attribute information.

17. A system according to claim 10, wherein
the attribute information of each member includes a hardware identification number identifying hardware used by the member, and
the authentication means accepts a hardware identification number from hardware used by a member and stores the hardware identification number in the attribute information database and, in the case in which the currently identified member is a previously identified member, references the hardware identification number stored in the attribute information database, and identifies whether or not there is a match between the part of the credit card member number and the hardware identification number and those of any credit card member
